(19) United States
(12) Patent Application Publication
(10) Pub. No.: US 2023/0189803 A1
(43) Pub. Date: Jun. 22, 2023

(54) COMPOSITIONS CONTAINING ORGANIC ACIDS AND THEIR ESTERS TO PREVENT MOLD CONTAMINATION IN ANIMAL FEED

(71) Applicant: KEMIN INDUSTRIES, INC., DES MOINES, IA (US)

(72) Inventors: Hilde WOUTERS, Zandhoven (BE); Jatuporn SALAKLANG, Clive, IA (US); Ingrid SOMERS, Kasterlee (BE); Sandy VAN DE CRAEN, Meerhout (BE); Filip NUYENS, Geel (BE); Agnes Hwee Hong THNG, Hougang (SG)

(73) Assignee: KEMIN INDUSTRIES, INC., DES MOINES, IA (US)

(21) Appl. No.: 18/084,539

(22) Filed: Dec. 19, 2022

Related U.S. Application Data
(60) Provisional application No. 63/290,754, filed on Dec. 17, 2021.

(51) Int. Cl. A01N 37/14; A01N 37/02; A01N 37/06; A01P 3/00

(52) U.S. Cl. CPC A01N 37/14; A01N 37/02; A01N 37/06; A01P 3/00

(57) ABSTRACT

The present invention relates to compositions that can be used as effective agents for prevention and protection of feed ingredients, particularly from mold growth, and methods for preparing the same. Another aspect relates to compositions containing synergistic combinations of propionic esters, free propionic acid, and propionic salts, capable of protecting against mold proliferation. Another aspect of the present invention relates to providing a user-friendly, non-corrosive approach for controlling mold growth in animal feed.

### CROSS-REFERENCE TO RELATED APPLICATIONS

The present application claims the benefit of priority to U.S. Provisional Patent Application No. 63/290,754, filed Dec. 17, 2021, entitled “Compositions Containing Organic Acids and Their Esters to Prevent Mold Contamination in Animal Feed,” the entire disclosure of which is incorporated herein by reference in its entirety.

### BACKGROUND OF THE INVENTION

Mold growth during storage of grain is a leading cause of deterioration of grain. As such, preventing mold growth during storage is essential to retaining grain quality and to preserve the nutritional value of the grain. Successful prevention of mold growth not only helps to preserve nutrients, it can also help to reduce the formation of harmful mycotoxins.

Volatile fatty acids (VFA), such as propionic acid and lactic acid, are known to be effective as mold inhibitors for the human food and animal feed industries. Myco CURB® products (Kemin Industries, Inc.) are designed to protect grains, feed ingredients and feed from mold contamination during storage. Propionic acid is one of the key active ingredients. However, the drawbacks to propionic acid are well documented. Propionic acid is corrosive to metal containers and safe handling is required in order to minimize exposure. See Rutenberg, R., Bernstein, S., Fallik, E., Paster, N. and Poverenov E., The improvement of propionic acid safety and use during the preservation of stored grains, Crop Protection, 110, 191-197 (2018).

The Myco CURB products include blends of organic acids and surfactants. Over time, Myco CURB has been proven to be a highly effective product for mold inhibition. Despite this high efficacy and reception in the market, the physical and chemical properties of propionic acid can prove to be challenging depending on the application, including for instance, the high evaporation and vaporization rate of the ingredients during storage, the corrosive vapor due to evaporation of the ingredients, the loss of active ingredients during palletization, and the pungent odor. These hurdles are experienced across the industry.

To date, industry experts have worked to overcome these hurdles through exploring various additives, acid-buffer, or modified lignosulphonic acids or glycerides exclusively focused on glyceryl propionate. Although there has been substantial investment and effort within the industry to improve some of the less desirable characteristics of Myco CURB®, as well as efforts to improve its overall efficacy, those efforts have focused on the inclusion of additives, for example essential oils and surfactants such as monopropylene glycol (MPG), with the aim of lowering the corrosivity of the final product. Indeed, many in the industry have worked to identify and develop a liquid product that is less corrosive than Myco CURB, while still maintaining its high mold inhibition efficacy.

The results of these efforts have been underwhelming, however. Most studies reported only modest improvement through reformulation efforts, focused on the addition of MPG, essential oils, aldehyde (cinnamaldehyde), and other acids (e.g. undecylenic acid), or organic salts. See Carrie Higgins and Friedhelm Brinkhaus, Efficacy of several organic acids against molds, J. Applied Poultry Science, 480-487 (1999); Maide Raeker, Preservation of high moisture corn by propionate treatment, Thesis Iowa State University (1990); Qu Su et al., Cinnamaldehyde, a Promising Natural Preservative Against Aspergillus flavus, 2895 (2019); Hai Meng Tan, Jesuadimai Ignatius Xavier Antony, Goh Swee Keng, Mold inhibitor having reduced corrosiveness, WO 2004/077923A2 (2004).

Thus, there remains a need for a superior mold-inhibitor for animal feed, where the ideal product would have a lower evaporation rate than propionic acid, a lower pungent acidic odor than propionic acid, and a lower degree of corrosion.

### SUMMARY OF THE INVENTION

The present invention relates to methods for preparation of active formulas based on carboxylic acids esters of C₁-C₂₀ by which the compounds being generated from monopropylene glycol, with excess of short-chain fatty acids of C₁-C₅ in compositions. Another aspect of the present invention relates to compositions that can be used as effective agents for prevention and protection of feed ingredients, particularly from mold growth. Another aspect relates to compositions containing synergistic combinations of propionic esters, free propionic, and propionic salts, which provide a balanced solution to protect against mold proliferation. Another aspect of the present invention relates to providing a user-friendly, non-corrosive approach for controlling mold growth, where the method is also capable of providing long-term protection to animal feed against mold growth. Another aspect of the present invention relates to a method for conferring desirable properties to animal feed, including for instance moisture retention during dry conditions and improved spreading of the product in matrices with high acid binding capacity.

### BRIEF DESCRIPTION OF THE FIGURES

FIG. 1 is the HPLC chromatograms for valeric acid (at 5.309 min).

FIG. 2 is the HPLC chromatograms for the reaction mixture comprising of valeric acid (at 5.318 min), valeric acid monoesters (at 7.436 min) and valeric acid diester (at 7.959 min).

FIG. 3 is the ¹³C NMR spectrum of esterification product containing mono, di-ester of propylene glycol propionate in a reaction mixture after esterification reaction between propionic acid and propylene glycol.

FIG. 4 Volatility of propionic acid esters compared to propionic acid

FIG. 5 Corrosivity of the vapours of new propionic acid ester mixtures compared to

Myco CURB ES liquid

FIG. 6 CO2 study in barley samples to show efficacy of esters compared to propionic acid.

FIG. 7 CO2 study in barley samples to show efficacy of esters compared to propionic acid.

FIG. 8 CO2 study in barley samples to show efficacy of esters compared to propionic acid.

FIG. 9 CO2 study in barley samples to show efficacy of esters compared to propionic acid.

FIG. 10 CO2 study in barley samples to show efficacy of MPG-propionic acid esters compared to other esters

FIG. 11 CO2 study in barley samples to show efficacy of new prototypes compared to Myco CURB ES liquid.

FIG. 12 CO2 study in barley samples to show efficacy of new prototypes compared to Myco CURB ES liquid.

FIG. 13 CO2 study in barley samples to show efficacy of new prototypes compared to Myco CURB ES liquid.

FIG. 14 CO2 study in barley samples to show efficacy of new prototypes compared to Myco CURB ES liquid.

FIG. 15 CO2 study in barley samples to show efficacy of new prototypes compared to Myco CURB ES liquid.

FIG. 16 CO2 study in barley samples to show efficacy of new prototypes compared to Myco CURB ES liquid.

FIG. 17 CO2 study in barley samples to show efficacy of new prototypes compared to Myco CURB ES liquid.

FIG. 18 CO2 study in soybean meal samples to show efficacy of MPG-propionic acid esters compared to propionic acid.

FIG. 19 CO2 study in soybean meal samples to show efficacy of MPG-propionic acid esters compared to propionic acid.

FIG. 20 CO2 study in barley samples to show efficacy of MPG-valeric acid esters compared to Myco CURB ES liquid

FIG. 21 is a photo showing the press for production of feed pellets.

FIG. 22 is a photo showing a feed pellet.

FIG. 23 Moisture retention capacity of MPG propionic acid esters compared to propionic acid and MPG. Kinetics

FIG. 24 summarizes the extrapolated moisture loss 10 hrs after treatment of feed with water (control), MPG, propionic acid (PA) and propylene glycol propionate ester (Ester).

### DETAILED DESCRIPTION OF THE INVENTION

The present invention relates to compositions comprising carboxylic acid esters of monopropylene glycol that can be used for preventing the growth of mold. These novel formulations show at least similar efficacy for mold inhibition as commercially available products, such as Myco CURB ES Liquid, while also showing significant improvement in terms of physico-chemical characteristics, for instance a lower evaporation rate of the active ingredients, less corrosive, and improved odor.

Another aspect of the present invention also relates to novel formulas containing monopropylene glycol that are capable of providing enhancing feed milling efficiency. Another aspect relates to the option of providing improved moisture retention for the feed, or pellets, during storage under dry conditions, for instance in the summer months.

Another aspect of the present invention relates to the use of esters of carboxylic acids to hinder acid binding sites in a feed or feed material matrix, for example in soybean meal. This brings additional efficacy to future products compared to a base product consisting of propionic acid or its salts which binds to the acid binding sites in a feed matrix (limiting the diffusion of propionic acid). The potential to use esters, particularly fatty acids esterified propylene glycol, is particularly desirable. In at least one embodiment, the compositions of the present invention include formulations based on a mixture of fatty acid and propylene esters of propionic acid or derivatives. In another embodiment, the compositions of the present invention include formulations based on a mixture of fatty acid and propylene esters of valeric acid or derivatives.

Another aspect of the present invention relates to providing compositions that surprisingly and unexpectedly possess efficacy while at the same time exhibit low volatility/low corrosion compared to other conventionally used organic acids. This efficacy is particularly surprising and advantageous, due to the overall improvement on the physico-chemical properties

For instance, according to at least one embodiment, propylene glycol propionates are added as a surfactant in an amount effective to decrease the surface tension. However, the addition of this component surprisingly and unexpectedly, facilitates the formation of the molecules into a product with lower vapor pressure, which stands in contrast to propionic acid in solution.

Additionally, according to at least one embodiment of the present invention, the composition includes propylene glycol propionate even at a low amount, for instance about 11% or lower) in combination with at least one salt other than sodium salt e.g., ammonium propionate salt, ammonium valerate salt, and at least one surfactant e.g. sorbitane monooleate, glyceryl monooleate, EL48 glyceryl peg ricinoleate—ethoxylated castor oil.

By way of non-limiting example, the at least one salt includes but is not limited to ammonium propionate salt and at least one surfactant.

The composition consisting of propylene glycol propionate and/or valerate esters of minimum amount of 11% wt. in the solution, ammonium propionate (minimum 10% wt.), propionic acid or fatty acids (minimum 5%), surfactant (minimum 1% wt.) and water leads to a stable product at pH above 5 without aggregation or precipitation and no ester degradation, The way of formulating is non-obvious for the expert in the field respect to product stability, physical properties (vapor pressure, degradation) and efficacy standpoints.

According to at least one embodiment, the composition includes propylene glycol valerates and valeric acid mixture in an amount ranging from about 0.02 mol/Kg feed or 3.5 kg/ton feed for feed at high moisture content of 19% or above.

According to at least one embodiment of the present invention, the composition is a liquid or dry product. In certain embodiments, the composition is a liquid product that can be applied to the animal feed, for instance the liquid can be mixed with the animal feed ingredients or alternatively incorporated using a spray application. According to at least one embodiment, the viscosity of the composition is similar to water.

In alternative embodiments, the composition is a dry powder that can be incorporated into animal feed or feed ingredients, or in alternative embodiments, the dry powder can be incorporated into the feed or feed ingredients.

According to at least one embodiment, the mold inhibitor composition contains at least one propylene glycol ester of propionic acid or derivatives. In alternative embodiments, the mold inhibitor composition contains at least one propylene glycol ester of valeric acid or derivatives.

According to at least one embodiment, the at least one propylene glycol ester is propylene glycol mono-, and di-ester. In certain embodiments, the at least one propylene glycol ester is derived from monopropylene glycol.

According to at least one embodiment, the composition of the present invention further comprises a blend of other organic acids, surfactants, or co-surfactants.

According to at least one embodiment, the composition of the present invention further comprises at least one organic acid. For instance, in certain embodiments, the at least one organic acid is selected from the group consisting of propionic acid, acetic acid, sorbic acid, benzoic acid, or combinations thereof.

In alternative embodiments, the at least one organic acid includes an acid selected from the group consisting of short-chain or medium-chain organic acids. In certain embodiments, the at least one organic acid includes short-chain acids that are generally deemed corrosive, which can reduce the life of manufacturing equipment. In certain embodiments, the at least one organic acid includes acids that have a strong or pungent odor, or other undesirable physical traits readily identified by persons of ordinary skill in the art.

According to at least one embodiment, the composition of the present invention includes at least one fatty acid.

According to at least one embodiment, the composition of the present invention further comprises a carboxylic acid salt. In certain embodiments, for instance, the carboxylic acid salt is ammonium propionate salt.

According to at least one embodiment, the present invention optionally comprises one or more antioxidants. In certain embodiments, the composition includes a natural antioxidant that is extracted from a plant. In alternative embodiments, the composition includes a synthetic antioxidant such as BHA, BHT, or TBHQ, or combinations thereof.

According to at least one embodiment, the present invention optionally comprises at least one flavoring agent or at least one colorant.

According to at least one embodiment, the composition is an animal feed ingredient or additive to an animal feed ingredient that comprises at least one monopropylene glycol propionate and/or di-propylene glycol propionate in an amount ranging from about 1% to 90% weight, at least one organic acid in an amount ranging from about 1%-50% weight, at least one carboxylic acid salt, such as ammonium propionate salt, in an amount ranging from about 5-40% weight, and monopropylene glycol in an amount ranging from about 1-10% weight.

According to at least one embodiment, the composition of the present invention further comprises an acid buffer. In certain embodiments, for instance, the acid buffer is ammonium propionate.

According to at least one embodiment, the composition is added to the feed in a dosage that ranges from about 0.1 to 10.0 kg per ton feed, for instance about 1.0 to 5.0 kg per ton feed. In certain embodiments, the composition is incorporated into the feed in an amount between about 2.5 to 4.0 kg per ton, or alternatively between about 2.7 to 5.0 kg per ton, or about 2.7 to 3.5 kg per ton.

According to at least one embodiment, the inclusion rate is at least 0.04 mol/kg. For instance, according to at least one embodiment, the inclusion rate falls within the range of about 0.04 to 0.1 mol/kg, for instance between about 0.06 to 0.08 mol/kg.

According to at least one embodiment, the composition has a pH between about 4 to 7. In certain embodiments the pH is adjusted to the desired range, for instance between about 5 to 7, or alternatively between about 5 to 6, or about 6 to 7.

According to at least one embodiment, the composition is added to animal feed with moisture content up to 22%, or alternatively up to 30%, and in alternative embodiments the animal feed or food product has a moisture content in the range of about 12-15%.

Another aspect of the present invention relates to a method for reducing mold contamination in feed or food, comprising the step of adding to the feed or the feed ingredients a composition that contains at least one propylene ester or derivatives in an amount effective to inhibit or delay the growth of mold, wherein the composition is less corrosive to stainless steel than propionic acid alone and the composition has a lower vapor pressure than propionic acid under the same physical conditions.

In certain embodiments, the composition includes at least one propylene glycol ester is propylene glycol mono-, and di-ester. In certain embodiments, the composition further comprises one or more organic acids selected from the group consisting of propionic acid, acetic acid, sorbic acid, and benzoic acid. In certain embodiments, the composition further comprises at least one fatty acid. In certain embodiments, the composition further comprises at least one surfactant.

Another aspect of the present invention relates to a method for extending the shelf-life of animal feed or feed ingredients by preventing contamination of mold comprising incorporating in said animal feed or feed ingredients, alone or in combination:
at least one monopropylene glycol propionate and/or di-propylene glycol propionate in an amount ranging from about 1% to 90% weight,
at least one organic acid in an amount ranging from about 1%-50% weight,
at least one carboxylic acid salt in an amount ranging from about 5-40% weight, and
monopropylene glycol in an amount ranging from about 1-10% weight.

In certain embodiments, the ingredients are blended into the feed alone or in combination.

In certain embodiments, the compositions of the present invention are incorporated into feed or feed components at a rate of at least 1% by weight. In certain embodiments, the composition is applied by spraying the composition onto the animal feed or feed ingredients.

Persons of ordinary skill in the art will appreciate that minor modifications or substitutions can be made to the composition and still fall within the scope and spirit of the present invention.

### EXAMPLES

At laboratory scale, several liquid mixtures-based esters were prepared from an acid catalyzed-esterification of fatty acids (C₁-C₂₀) e.g., propionic, lactic, ricinoleic acid or VFAs from natural sources for example castor oil etc., reacted with monopropylene glycol (MPG). The study also targeted the preparation of compounds to be used as surfactants by reacting the hydroxyl moieties of MPG with long chain fatty acids and/or flavors for improving pungent odor of the liquids.

### Example 1

### Synthesis of Propionic Acid Esters by Esterifying Propionic Acid with Monopropylene Glycol to Generate Mono-, Di-propylene Glycol Propionates Mixture

The reaction condition for preparation of carboxylic acid esters for example propionic acid ester was optimized in terms of reagent used (MPG) varying from 0.2 to 1.1 equivalent (to fatty acids), types and quantity of catalysts, temperature, and reaction time to form esters. The lab screening results showed the conversion of propionic acid into its esters at 20-70% (HPLC purity) depending on the reaction parameters and the catalyst used (Table 1).

TABLE 1
Examples of reaction conditions for synthesis
of propionic acid esters and derivatives

| | | | | % ester, mono, -di |
|---|---|---|---|---|
| | | Reaction | | ester |
| | | Temp¹(° C.)/ | | (% purity in a reaction |
| | Reaction | 6 hours of | Catalyst used/% | mixture measured |
| Entry | parameter | reaction time | weight | by % area HPLC) |
| 1 | 0.5 eq. MPG (0.675 | 70° C. | n/a | 8% of propionic acid |
| | mol, 51.4)/1.0 eq. | | | ester |
| | Propionic acid (1.35 | | | |
| | mol, 100 g.) | | | |
| 2 | 0.5 eq. MPG (51.4 | 60° C. | 0.5%; 0.75%; | ~42% ester (0.5% wt. |
| | g.)/1.0 eq. Propionic | | 1.0 % wt. | H₂SO₄) |
| | acid (1.35 mol, 100 g.) | | H₂SO₄ | ~47% ester (0.75% |
| | | | | H₂SO₄) |
| | | | | ~52% ester (1% wt. |
| | | | | H₂SO₄) |
| 3 | 0.5 eq. MPG (51.4 | 70° C. | 0.5%; 0.75 % wt. | ~54% ester (0.5% wt. |
| | g.)/1.0 eq. Propionic | | H₂SO₄ | H₂SO₄) |
| | acid (1.35 mol, 100 g.) | | 2.5% wt. | ~65% ester (0.75% |
| | | | solid catalyst | H₂SO₄) |
| | | | (with | ~50% ester (2.5% wt, |
| | | | possibility | solid catalyst) |
| | | | of recycling) | |
| 4 | 0.5 eq. MPG (51.4 | 70° C. | 2.5% wt. | 38% ester (1% wt. |
| | g.)/1.0 eq. Propionic | | H₃PO₄ | H₂SO₄) |
| | acid (1.35 mol, 100 g.) | | | |
| 5 | 0.5 eq. MPG (51.4 | 70° C. | 1.0% wt. | ~58% ester (0.75% |
| | g.)/1.0 eq. Propionic | | HCl (36% wt.) | H₂SO₄) |
| | acid (1.35 mol, 100 g.) | | | |
| 6 | Step-1) Propionic | 70° C. | 1.0% wt. | 60% esters, a |
| | acid (1.35 mol) | | H₂SO₄ | combination of mono, |
| | reacted with | | | di-propionic acid esters |
| | ricinoleic acid | | | |
| | containing hydroxy | | | |
| | group (0.2 mol); | | | |
| | Step-2) reaction of | | | |
| | step 1) mixture with | | | |
| | MPG (0.6 mol) | | | |
| 7 | Step-1) Propionic | 70° C. | 1.0% wt. | 65% esters, a |
| | acid (1.35 mol) | | H₂SO₄ | combination of mono, |
| | reacted with lactic | | | di-propionic acid esters |
| | acid (0.5 mol) for 3 h; | | | |
| | Step-2) further | | | |
| | reaction using a | | | |
| | mixture obtained | | | |
| | from step 1) with | | | |
| | MPG (0.6 mol) for 6 h | | | |
| 8 | 1^{st} reaction: 1.0 eq. | 70° C. | 0.75% wt. | 1^{st} Rx. ~2% citronellyl |
| | Propionic acid (1.35 | | H₂SO₄ | propionate |
| | mol, 100 g.)/0.01 | | | 2^{nd} Rx. 54% propionic |
| | eq. citronellol (0.013 | | | acid ester combined |
| | mol); 2^{nd} reaction: | | | with citronellyl |
| | reacted with 0.5 eq. | | | propionate |
| | MPG (0.675 mol, | | | |
| | 51.4 g.) | | | |
| 9 | 1.0 eq. Propionic | 70° C. | 0.75% wt. | 54% propionic acid |
| | acid (1.35 mol, 100 | | H₂SO₄ | ester; % vanillyl |
| | g.)/0.01 eq. vanillin | | | propionate (not |
| | (0.0128 mol, 2 g)/ | | | determined) |
| | 0.5 eq. MPG (0.675 | | | |
| | mol, 51.4 g.) 70° C./ | | | |
| | 0.75% wt. H₂SO₄ | | | |

### Example 2

### Synthesis of Propionic Acid Esters with Flavors e.g. a Preparation of Liquid Mixtures of Monopropylene Propionate and Citronellyl Propionate by Esterifying an Excess of Propionic Acid from a Reaction Mixture of Example-1 with a Natural Extracted Citronella Alcohol (Citronellol) Via One Pot Procedure

The study also targeted preparation of ester compounds for flavouring the product. The reaction between propionic acid and flavors was carried out by esterifying propionic acid with hydroxyl moiety of the flavors e.g., vanillin, citronellol to create three different core formulas e.g. (i) a liquid mixture of propionic acid ester, (ii) a mixture of propionic acid ester incorporated with vanillin and (iii) an ester mixture with citronellyl propionate (reaction 8 and 9 in Table 1).

### Example 3

### Synthesis of Valeric Acid Esters by Esterifying Propionic Acid with Monopropylene Glycol to Generate Mono, Di-propylene Glycol Valerate Mixture

Synthesis of valeric acid esters via acid catalyzed esterification. 31.1 g (0.4 mol; 1 equivalent) of monopropylene glycol and 0.6 g (0.5%) of concentration sulphuric acid (98% wt.) was added into a three-necked round bottom flask with stirring. Subsequently, a total of 83.6 g (0.8 mol, 2 equivalents) of valeric acid was added in three portions with a dropping funnel with dropping rate 15-20 minutes per portion. The first portion (27.9 g) of valeric acid was added into the reaction mixture with stirring. The reaction mixture is subsequently heated and maintained at 50° C. for the next 30 minutes. After 30 minutes, the second portion (27.9 g) of valeric acid was added and subsequently heated and maintained at 70° C. for the next 30 minutes with stirring. Lastly, the last portion (27.9 g) of valeric acid was added into the reaction mixture and heated up to 100° C. The temperature of the reaction mixture is maintained at 100° C. for the next six hours. The reaction is monitored using HPLC over the next six hours. The reaction mixture is cooled to room temperature for work-up, after six hours.

Work-up procedure. Firstly, 50 g of the reaction mixture was transferred into the separatory funnel, followed by the addition of 3.0 g of anhydrous sodium acetate. Subsequently, 50 mL of tetrahydrofuran was added and mixed. The reaction mixture was adjusted to pH range of 5 to 8 with saturated sodium hydrogen carbonate using pH measuring strips. Phase separation was observed when pH is within the range. Discard the aqueous phase and wash the organic phase with water. After washing, discard the aqueous phase and collect the organic phase in a round bottom flask. The solvent was removed under vacuum to obtain the crude product containing esters. The percentage purity of the valeric acid and its esters were determined with the use of Agilent 1260 Infinity II LC system with diode array detector (DAD) at 210 nm. An aliquot of the reaction mixture was transferred to a HPLC vial and diluted 100 times prior to injection. Peak separation was achieved with an Agilent Zorbax SB-C18 column (5 μm, 4.6 mm×250 mm) with column temperature maintained at 30° C. Mobile phase was set as 35% acetonitrile (Fulltime; A6308) and 65% millipore water with 0.2% phosphoric acid (Merck; 1.00573.1000), with total flow rate at 1.0 mL/min.

### Results

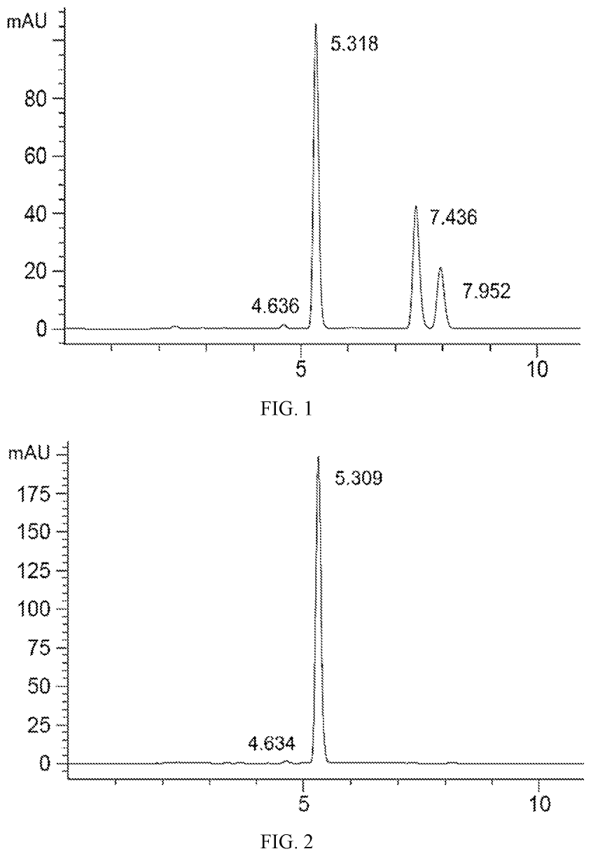

Percentage purity and stability of valeric acid esters. Retention times of valeric acid, monoesters and diester is determined to be at 5.309-5.316, 7.436 and 7.952 respectively (FIG. 1-2). High amount of unreacted valeric acid was observed at room temperature, accounting for 93.1%, indicating a minimal esters conversion (Table 2). Subsequently, a sharp drop in the amount of unreacted valeric acid was observed with heating, following an increase in the amounts of esters formed. Upon heating the reaction mixture to 100° C., the amount of unreacted valeric acid dropped from approximately 93.1% to 55.7% whereas the percentage of valeric acid esters increased from approximately 6.2% to 43.7%. Minimal changes in the percentage purity were observed over six hours, indicating no further ester conversion even with prolonged heating up to six hours. After work-up, the percentage purity of both mono and diesters increases. This is possibly due to the loss of valeric acid at the solvent evaporation step after work-up. Valerie acid esters were further purified through vacuum evaporation to remove excess valeric acid for CO₂ production test.

TABLE 2
Percentage purity of valeric acid and esters at room temperature
and every hour interval after heating to 100° C.

| | Percentage purity by HPLC (%) | | |
|---|---|---|---|
| | Valeric | | |
| Sample | acid | Monoesters | Diester |
| Room temperature* | 93.1 | 4.1 | 2.1 |
| 0 hour at 100° C. | 56.3 | 28.2 | 14.7 |
| 1 hour at 100° C. | 54.8 | 29.2 | 15.2 |
| 6 hours at 100° C. | 55.7 | 28.5 | 15.2 |

*An aliquot was transferred out from the round bottom flask and diluted for HPLC analysis prior to heating up the reaction mixture in the round bottom flask.

### Example 4

### Upscaling of Propionic Acid Esters by Esterifying Propionic Acid with Monopropylene Glycol to Generate Mono-, Di-Propylene Glycol Propionates Mixture

The results from laboratory screening (Example 1) reveals that the reaction condition of Entry-3 showed the most optimum reaction condition in terms of ester conversion by converting propionic acid into its ester of up to 54% under the catalytic amount of 0.5% H2SO4 at 6 h/70° C.

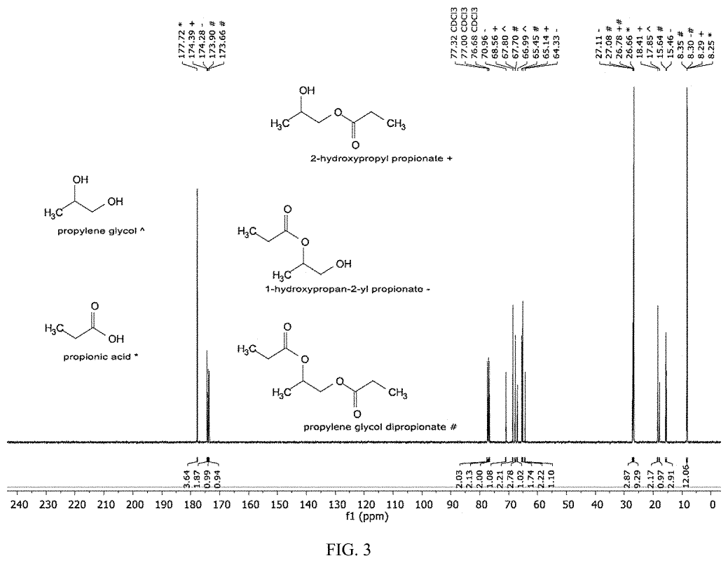

The selected condition was scaled up at 1 L and 5 L scale using 0.5 equiv. MPG reacting with 1.0 equiv. propionic acid under catalytic condition of 0.5% wt. H2SO4 for 10 hours of reaction time under a reaction temperature of 70° C. (bath temperature of 75° C., Table 3). The results from kilo-lab synthesis yielded ester of 50-60% (HPLC purity) in the mixture which is in a range of 47-52% (isolated molar yield). The compostions of reaction mixture and isolated esters were characterized via—¹³C-NMR (FIG. 3, Table 4).

TABLE 3
Kilogram scale and pilot scale production of propionic acid esters

| | | Reaction | | % ester |
|---|---|---|---|---|
| | | Temp1 | | purity (% |
| | Reaction | (° C.)/Rx. | Catalyst | area by |
| Entry | parameter | Time (h.) | used | HPLC) |
| 1 | 0.5 eq. MPG | 70° C. | 0.5% wt. | 1 h |
| | (6.75 mol, | | H2SO4 | Rx: 41% |
| | 514 g)/ | | | 3 h |
| | 1.0 eq. | | | Rx: 51% |
| | Propionic | | | 5 h |
| | acid | | | Rx: 55% |
| | (13.5 mol, | | | 7 h |
| | 1000 g.) | | | Rx: 57% |
| | | | | 10 h |
| | | | | Rx: 60% |
| 2 | 0.5 eq. MPG | 60° C. | 0.5% wt. | 1 h |
| | (20.25 mol, | | H2SO4 | Rx: 28% |
| | 1540 g.)/ | | | 3 h |
| | 1.0 eq. | | | Rx: 37% |
| | Propionic | | | 5 h |
| | acid | | | Rx: 40% |
| | (54 mol, | | | 7 h |
| | 3000 g.) | | | Rx: 45% |
| | | | | 9 h |
| | | | | Rx: 51% |
| | | | | 10 h |
| | | | | Rx: 53% |
| 3 | 201 KG. | 50-55° C. | 0.5% wt. | 8 h |
| Pilot | MPG/398 KG | | (3 KG) | RX: ~55% |
| scale at 600 | Propionic | | H2SO4 | HPLC |
| KG production | acid | | | purity |

TABLE 4
Compositions of reaction mixtures and the extracted
propylene glycol propionate esters

| | | % Compositions of | |
|---|---|---|---|
| | | reaction mixture | % Composition |
| | | (After esterification | Extracted ester |
| | | reaction at pilot production | (after workup |
| Compositions | Structure | at 600 KG scale) | under vacuum) |
| propionic acid | | 48 | 2 |
| propylene glycol | | 9 | 2 |
| 2-hydroxypropyl propionate | 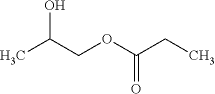 | 19 | 19 |
| 1 -hydroxypropan- 2-yl propionate | 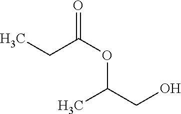 | 9 | 9 |
| propylene glycol dipropionate | 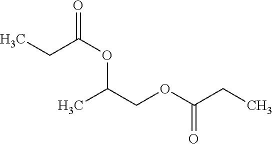 | 15 | 68 |
| trace | n/d | — | 0.2 |

### Example 5

### Formulation of Prototypes Containing Carboxylic Acid Esters e.g. Monopropylene Glycol Mono,Di-Propionates Formulating with a Buffer Solution of Ammoniated Propionic Acid or Ammonium Propionate

The liquid product from Example-1 containing propionic acid esters of monopropylene glycol were further formulated with ammonium propionate. A buffer solution of ammonium propionate (50% wt.), 100 grams was added slowly to a glass-lined flask (1 L) containing 400 grams a liquid mixture of propionic acid esters, monopropylene glycol and propionic acid. The temperature of the mixture was monitored while adding an acid buffer to generate a prototype with a pH of 4.0-4.5.

### Example 6

### Formulation of Prototypes with Flavor Containing Carboxylic Acid Esters e.g. Monopropylene Glycol Mono,Di-Propionates and Citronellyl Propionate or Vanillyl Propionate Formulating with a Buffer Solution of Ammoniated Propionic Acid or Ammonium Propionate

A reaction mixture obtained from Example-2 containing propionic acid esters of monopropylene glycol and citronellyl propionate of vanillyl propionate were further formulated with ammonium propionate. A buffer solution of ammonium propionate (50% wt.), 100 grams was added slowly to a glass-lined flask (1 L) containing 400 grams a liquid mixture of propionic acid esters, monopropylene glycol and propionic acid. The temperature of the mixture was monitored while adding an acid buffer to generate a prototype with a pH of 4.0-4.5. The final compositions of prototypes contain propionic acid esters (30-35% wt.), propionic acid (˜15%), ammonium propionate (10-20%), monopropylene glycol (˜8%) citronellyl propionate/citronellol or vanillyl propionate/vanillin (0.1% wt) and water.

### Example 7

### Evaluation of Liquid Prototypes from Example-1, Example-2, Example-5, Example-6 in Terms of Acid Volatility Rate, Degree of Corrosion, Odor Improvement

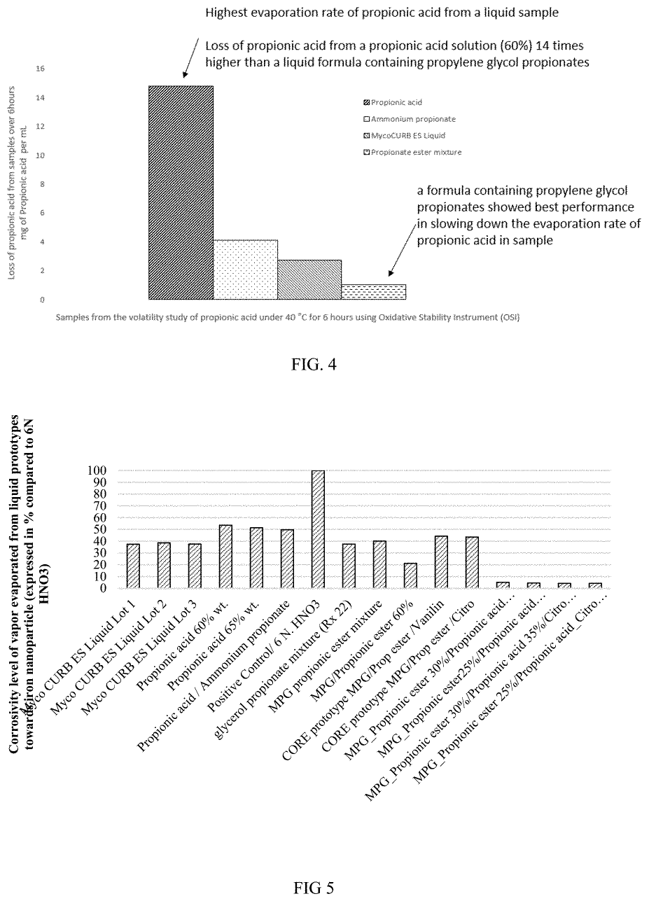

The new prototypes (˜35% esters) showed significant improvement in terms of evaporation of active components by 10-14 times lower than propionic acid (65 wt. %) and approx.3-5 times lower than the current formula of Myco CURB ES Liquid (FIG. 4). In addition, as summarized in FIG. 5, the corrosion results showed the vapours of the new prototypes were less aggressive towards iron oxide nanoparticles and stainless-steel.

### Example 8

### Synthesis of Propionic Acid Esters by Esterifying Propionic Acid with Polyol for Example β Cyclodextrin or Maltodextrin

Propionic acid (1.35 mmol, 1 equiv.) was reacted and its corresponding alcohol for β-cyclodextrin (0.5 mol.) and for maltodextrin 0.2 mol. were added into a 250 mL or a 500 mL round-bottom flask at room temperature. An aliquot of 98% H2SO4 (1% wt. respect to the total amount of reaction mixture was slowly added (by dropping funnel) to the flask containing a mixture of propionic acid and β-cyclodextrin or maltodextrin. The reaction was stirred for 12 h at 60° C. (65° C. oil-bath temperature) and at 70° C. (75° C. oil-bath temperature). The reaction mixture was subjected for sampling (0.5 mL) every hour for analysis. The reaction conversion was observed by HPLC until the reaction reached its maximum conversion of propionic acid into its ester over period of reaction time.

### Example 9

### Dose Response Study on Propionic Acid Esters as Mold Inhibitors

Materials. Barley was procured from a local supplier. The composition of the extracted propylene glycol propionate esters is shown in Table 5.

TABLE 5
Description of the esters (after reaction).

| Formulation | Description |
|---|---|
| Ester 1 | mixture of extracted propylene glycol propionate |
| | mono- and diesters (ratio 80:20) |
| Ester 2 | mixture of extracted propylene glycol propionate |
| | mono- and diesters (ratio 80:20) and citronellyl |
| | propionate |

Efficacy. The moisture level of barley was determined before the start of the experiments4. The moisture level of the barley samples was adjusted to 20.2+/−0.5% by the addition of tap water. The barley samples, with the adjusted moisture content, were afterwards treated with the different extracted esters at different dose levels (0.02 mol/kg, 0.04 mol/kg, 0.06 mol/kg and 0.08 mol/kg). The untreated barley samples and samples treated with propionic acid (0.02 mol/kg-0.08 mol/kg) were included as controls. An overview of the treatments is shown in Table 6. All barley samples were collected in closed plastic containers for evaluation of the CO2-production. The samples were stored at 25° C. The CO2-production in the headspace was monitored regularly during a 3-month period using the Edinburgh sensor Guardian NG. Three replicates were analyzed for each treatment.

TABLE 6
Overview of the different treatments of the efficacy test.

| Moisture | | Dosage product |
|---|---|---|
| level | Product | (mol/kg) |
| 20.2% | Untreated control | 0.00 |
| | Ester 1 | 0.02 |
| | Ester 1 | 0.04 |
| | Ester 1 | 0.06 |
| | Ester 1 | 0.08 |
| | Ester 2 (with citronellol) | 0.02 |
| | Ester 2 (with citronellol) | 0.04 |
| | Ester 2 (with citronellol) | 0.06 |
| | Ester 2 (with citronellol) | 0.08 |
| | Propionic acid | 0.02 |
| | Propionic acid | 0.04 |
| | Propionic acid | 0.06 |
| | Propionic acid | 0.08 |

Statistical analysis. To determine significant differences in CO2-values values (p<0.05), repeated measures analysis was performed by method of General Linear Models procedure (StatGraphics Centurion XV). The repeated measures statistical treatment of results was used because it can be used when change over time is assessed. Where significant differences resulted, Multiple Range Test was used to separate the means.

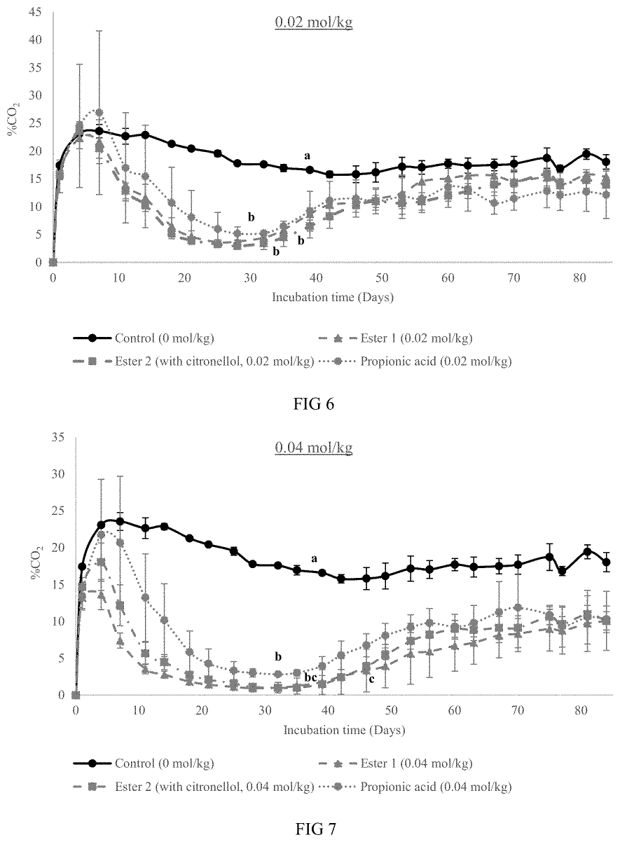

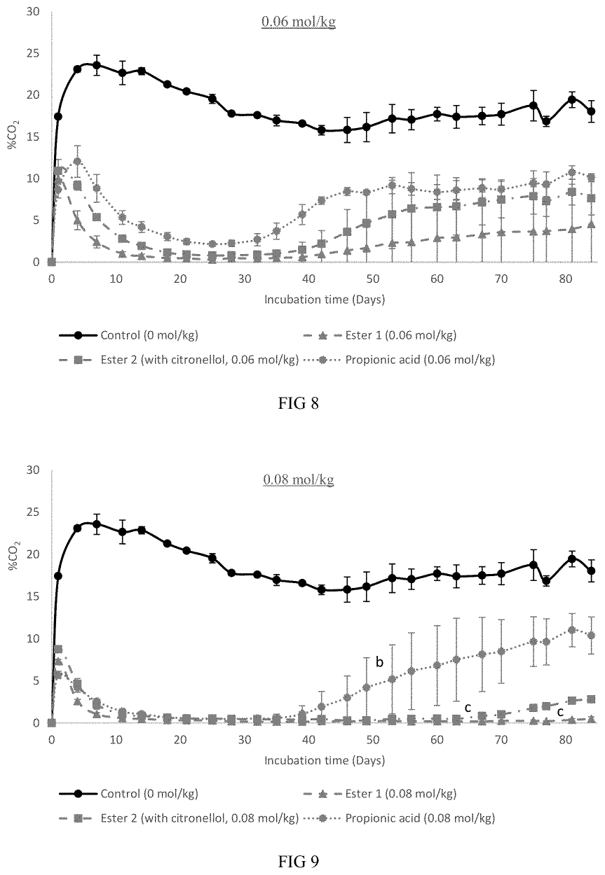

Results. As shown in FIGS. 6-9, the CO2-production (%) of the untreated barley samples compared to the barley samples treated with ester 1, ester 2 (with citronellol) and propionic acid at a dosage of 0.02, 0.04, 0.06 and 0.08 mol/kg, respectively. In most samples, a very fast increase in CO2 levels was measured within the first days. In the untreated samples, the CO2 level stayed around 20% during the whole course of the trial. In the treated samples, CO2 levels decreased again after a few days. The CO2 production was statically significantly lower for all tested treatments compared to the untreated control, even at the lowest dosages. After one month of storage, CO2 levels started to increase again in all samples treated with 0.02 mol/kg-0.06 mol/kg. CO2 increased faster in samples treated with 0.06 mol/kg propionic acid compared to samples treated with 0.06 mol/kg of the esters. Over the course of this study, the CO2-level of the barley treated with 0.06 or 0.08 mol/kg of the esters was statistically lower compared to the barley samples treated with the same dosage of propionic acid. Samples treated with ester 1 and ester 2 at a concentration of 0.08 mol/kg were still completely stable after 84 days, while CO2 started increasing after 40 days in the samples treated with 0.08 mol/kg propionic acid.

Conclusion. A dose response study was performed to compare the mold inhibitor capacity of the extracted propionate esters with propionic acid on a molar basis. The fast, early increase in CO2-levels at the beginning at the study is probably due to grain respiration. The CO2 evolution study of the artificially moistened barley samples (20.2% moisture) demonstrated that at dosages of 0.06 mol/kg and 0.08 mol/kg the extracted propionate esters performed significantly better in controlling mold growth than propionic acid. The lower efficacy of propionic acid might be explained by its higher volatility compared to the esters. The lower volatility of the esters could contribute to a longer ability of the products to inhibit mold growth during storage.

### Example 10

### Comparison of the Mold Inhibitor Capacity of the Propylene Glycol Esters with Other Esters as Methyl Propionate

The objective of the study was to compare the mold inhibitor capacity of the propylene glycol propionate esters with other propionate esters, to show that not all propionate esters are effective and that the MPG esters are unique.

Materials. The moisture level of barley samples was increased till 20.2%. An overview of the different treatments is shown in Table 7.

TABLE 7
Overview of the different treatments of the efficacy test.

| Moisture | | Dosage product |
|---|---|---|
| level | Product | (mol/kg) |
| 19.8% | Untreated control | 0.00 |
| | Propylene glycol propionate | 0.02 |
| | ester mix* | |
| | Propylene glycol propionate | 0.04 |
| | ester mix | |
| | Propylene glycol propionate | 0.06 |
| | ester mix | |
| | Propylene glycol propionate | 0.08 |
| | ester mix | |
| | Methyl propionate ester | 0.02 |
| | Methyl propionate ester | 0.04 |
| | Methyl propionate ester | 0.06 |
| | Methyl propionate ester | 0.08 |
| | Propionic acid | 0.02 |
| | Propionic acid | 0.04 |
| | Propionic acid | 0.06 |
| | Propionic acid | 0.08 |
| | Ethyl acetate ester | 0.02 |
| | Ethyl acetate ester | 0.04 |
| | Ethyl acetate ester | 0.06 |
| | Ethyl acetate ester | 0.08 |
| | Acetic acid | 0.02 |
| | Acetic acid | 0.04 |
| | Acetic acid | 0.06 |
| | Acetic acid | 0.08 |

*Mixture of extracted and purified propylene glycol propionate mono- and diesters (ratio 80:20), prepared in the lab.

Statistical analysis. To determine significant differences in CO2-values (p<0.05), repeated measures analysis was performed by method of General Linear Models procedure (StatGraphics Centurion XV). The repeated measures statistical treatment of results was used because it can be used when change over time is assessed. Where significant differences resulted, Multiple Range Test was used to separate the means.

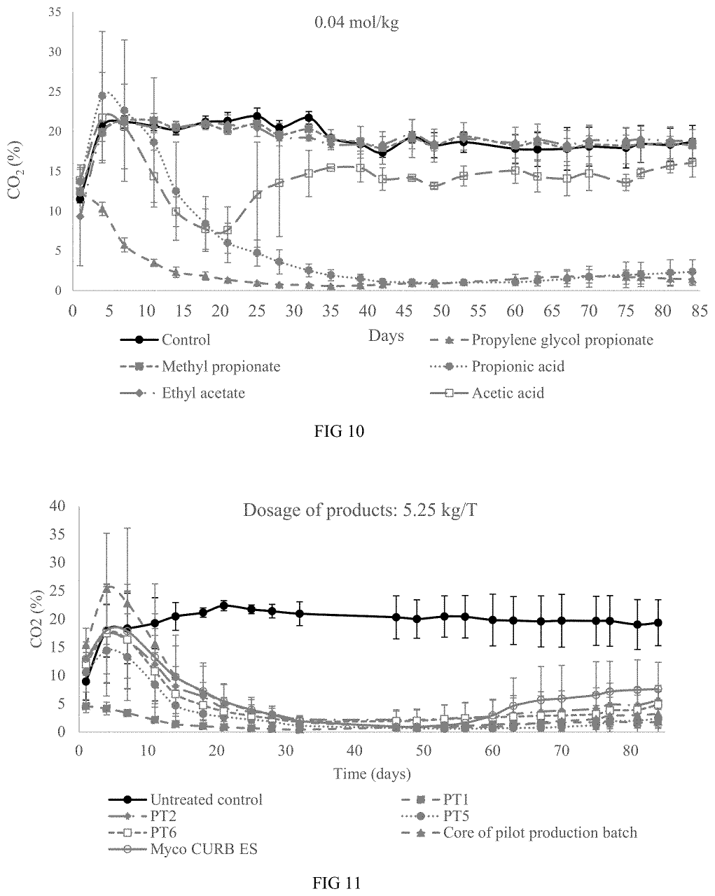

Results. A dose response study was performed to compare the mold inhibitor capacity of the extracted and purified propylene glycol propionate esters with other esters as methyl propionate and ethyl acetate and organic acids as propionic acid and acetic acid on a molar basis. The CO2 evolution study of the artificially moistened barley samples (19.8% moisture) demonstrated that the extracted and purified propylene glycol propionate ester performed significantly better in controlling mold growth than the volatile short chain esters methyl propionate and ethyl acetate esters. Over the course of this study, the CO2-level of the barley treated with 0.04 mol/kg of propylene glycol propionate was statistically lower compared to the barley samples treated with the same dosage of propionic acid (FIG. 10). The lower efficacy of propionic acid might be explained by its higher volatility compared to the esters. The barley samples treated with acetic acid were less effective in controlling mold growth compared to propionic acid.

Conclusion. In this study, we demonstrated the higher effectiveness of the propylene glycol propionate ester to control mold growth compared to other esters as methyl propionate and ethyl acetate and organic acids propionic acid and acetic acid.

### Example 11

### Slow Release of Propionic Acid from Propionic Acid Esters, Long Lasting Efficacy Against Moulds

Method. Barley samples (22% moisture) were either treated with 7 kg/T propylene glycol propionate (mixture of propylene glycol propionate mono- and diesters (ratio 80:20)), or not treated. The samples were incubated at 22° C. for 4 weeks. After four weeks, the samples were incubated at 40° C. for 3 hours. During this incubation at elevated temperature, a constant air was purged through the samples. The volatile acids were trapped in recipient tube at room temperature. The volatile acids were measured in the receiving tubes using HPLC-UV at 210 nm.

Results: In the receiving tubes propionic acid could be detected. This indicates slow release of propionic acid (due to hydrolysis) from the propylene glycol propionate esters during storage of the grains. This might explain the sustained protection of the barley samples by propylene glycol propionate.

### Example 12

### Evaluation of Liquid Prototypes from Example-5, Example-6, in Terms of CO2 Efficacy Study in Comparison to the Myco CURB ES Liquid

The objective of the current study was to evaluate if the new prototypes have a similar or better mold inhibitor capacity than the current Myco CURB ES liquid.

Method. Different prototypes were prepared based on propylene glycol propionate esters, ammonium propionate and propionic acid (Table 8). Three trials were setup in which the efficacy of the prototypes was compared to Myco CURB ES liquid in barley samples with moisture levels between 19.2%-20.4%. An overview of the treatments of the three trials is shown in Table 9.

Statistical analysis. To determine significant differences in CO2-values values (p<0.05), repeated measures analysis was performed by method of General Linear Models procedure (StatGraphics Centurion XV). The repeated measures statistical treatment of results was used because it can be used when change over time is assessed. Where significant differences resulted, Multiple Range Test was used to separate the means.

TABLE 8
Description of the core formulation and prototypes.

| | Formulation | Prototype composition |
|---|---|---|
| Core formulation | | |
| Core | Core of pilot production batch | Core based on a mixture of propionic acid |
| | | esters (~52-55%)/propionic acid (~23%), |
| | | Monopropylene glycol (MPG) (~14%) and |
| | | water (8%). |
| Prototypes | | |
| Prototype 1 (PT1) | Prototype based on a mixture of the | Composition after reaction: mixture of |
| | core (44.65%), propionic acid, | propionic acid esters (24.6%), propionic acid |
| | ammonium salt (2:1)* (44.65%) and | (25.7%), Ammonium propionate (18.5%), |
| | water (10.7%). | MPG (6.2%) and water (25.0%). |
| Prototype 2 (PT2) | Prototype based on a mixture of the | Composition after reaction: mixture of |
| | core (49.15%), propionic acid, | propionic acid esters (27.0%), propionic acid |
| | ammonium salt (1:1)* (49.15%) and | (11.3%), Ammonium propionate (31.2%), |
| | EL 48 (1.7%). | MPG (6.9%), water (21.9%) and EL 48 |
| | | (1.7%). |
| Prototype 5 (PT5) | Prototype based on a mixture of the | Composition after reaction: mixture of |
| | core (69.9%), propionic acid, | propionic acid esters (38.4%), propionic acid |
| | ammonium salt (2:1)*, water | (22.1%), Ammonium propionate (7.3%), |
| | (10.9%) and EL 48 (1.7%). | MPG (9.8%), water (20.7%) and EL 48 |
| | | (1.7%). |
| Prototype 6 (PT6) | Prototype based on a mixture of the | Composition after reaction: mixture of |
| | core (60.0%), propionic acid, | propionic acid esters (33.0%), propionic acid |
| | ammonium salt (2:1)* and water | (20.7%), Ammonium propionate (8.3%), |
| | (20.0%). | MPG (8.4%) and water (29.6%). |
| Alternative 1 (ALT1) | Prototype based on a mixture of the | Composition after reaction: mixture of |
| | core (20%), propionic acid, | propionic acid esters (11.0%), propionic acid |
| | ammonium salt (1.4:1)* (68%) and | (14.8%), Ammonium propionate (36.7%), |
| | tap water (12%). | MPG (2.8%) and water (34.7%). |
| Alternative 2 (ALT2) | Prototype based on a mixture of the | Composition after reaction: mixture of |
| | core (20%), propionic acid, | propionic acid esters (11.0%), propionic acid |
| | ammonium salt (2:1)* (68%) and tap | (28.0%), Ammonium propionate (28.3%), |
| | water (12%). | MPG (2.8%) and water (29.9%). |

*Propionic acid, ammonium salt (2:1): 68.28% of the mixture is propionic acid and 31.72% is ammonia 24.5%.
propionic acid, ammonium salt (1:1): equal equivalents of propionic acid and ammonia 24.5%.
propionic acid, ammonium salt (1.4:1): 58.82% of the mixture is propionic acid and 41.18% is ammonia 24.5%.

TABLE 9
Overview of the different treatments of the efficacy test.

| | | | Dosage |
|---|---|---|---|
| Efficacy | Moisture | | product |
| study | level | Product | (kg/T) |
| 1^{st} | 20.4 +/− 0.5% | Untreated control | 0.00 |
| | | Prototype 1 (PT1) | 3.50 |
| | | Prototype 2 (PT2) | 3.50 |
| | | Prototype 5 (PT5) | 3.50 |
| | | Prototype 6 (PT6) | 3.50 |
| | | Core | 3.50 |
| | | Myco CURB ES liquid (MC ES) | 3.50 |
| | | Prototype 1 (PT1) | 5.25 |
| | | Prototype 2 (PT2) | 5.25 |
| | | Prototype 5 (PT5) | 5.25 |
| | | Prototype 6 (PT6) | 5.25 |
| | | Core | 5.25 |
| | | Myco CURB ES liquid (MC ES) | 5.25 |
| | | Prototype 1 (PT1) | 7.00 |
| | | Prototype 2 (PT2) | 7.00 |
| | | Prototype 5 (PT5) | 7.00 |
| | | Prototype 6 (PT6) | 7.00 |
| | | Core | 7.00 |
| | | Myco CURB ES liquid (MC ES) | 7.00 |
| 2^{nd} | 19.7 +/− 0.5% | Untreated control | |
| | | Prototype 1 (PT1) | 2.625 |
| | | Prototype 1 (PT1) | 3.50 |
| | | Prototype 1 (PT1) | 4.375 |
| | | Prototype 1 (PT1) | 5.25 |
| | | Prototype 2 (PT2) | 2.625 |
| | | Prototype 2 (PT2) | 3.50 |
| | | Prototype 2 (PT2) | 4.375 |
| | | Prototype 2 (PT2) | 5.25 |
| | | Alternative 2 (ALT2) | 3.50 |
| | | Alternative 2 (ALT2) | 5.25 |
| | | Alternative 2 (ALT2) | 7.00 |
| | | Myco CURB ES liquid (MC ES) | 3.50 |
| | | Myco CURB ES liquid (MC ES) | 5.25 |
| | | Myco CURB ES liquid (MC ES) | 7.00 |
| 3^{rd} | 19.2 +/− 0.5% | Untreated control | |
| | | Myco CURB ES (MC ES) | 6.00 |
| | | Prototype 2 (PT2) | 4.00 |
| | | Prototype 2 (PT2) | 5.00 |
| | | Prototype 2 (PT2) | 6.00 |
| | | Alternative 1 (ALT1) | 4.00 |
| | | Alternative 1 (ALT1) | 5.00 |
| | | Alternative 1 (ALT1) | 6.00 |

### Results:

### Trial 1

FIG. 11 shows the CO2-production (%) of the untreated barley sample compared to the barley samples treated with the different prototypes, the core of the pilot production batch and Myco CURB ES liquid at a dosage of 5.25 kg/T. In most samples, an increase in CO2 levels was measured within the first days. In the untreated samples, the CO2 level stayed around 20% during the whole course of the trial. In the treated samples, CO2 level decreased again after a few days. The CO2 production was statistically lower for all tested treatments compared to the untreated control, even at 3.50 kg/T. After one month of storage, CO2 levels started to increase again in samples treated with 3.50 kg/T PT2, PT5, PT6 and Myco CURB ES liquid. Barley samples treated with 5.25 and 7.00 kg/T of PT1, PT2, PT5, PT6 and the core were still completely stable after 84 days.

### Trial 2

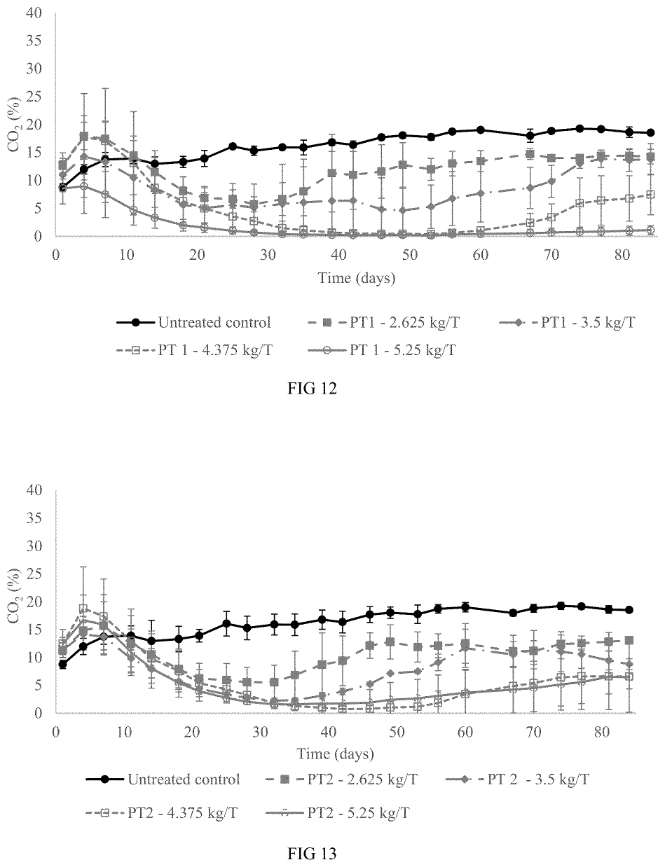

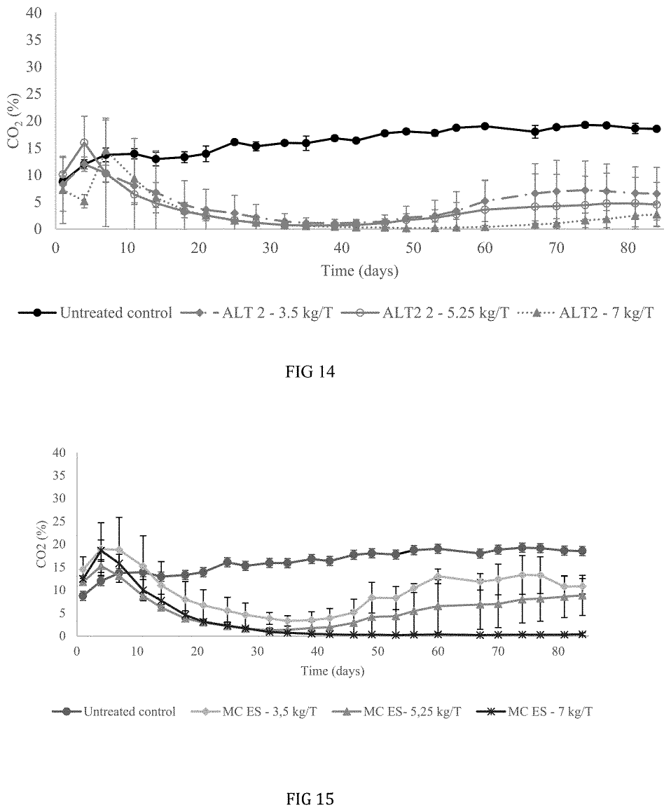

FIGS. 12, 13, 14 and 15 show the CO2-production (%) of the untreated barley samples compared to barley samples treated with different dosages of PT1, PT2, ALT2 and Myco CURB ES liquid, respectively. A clear dose-response relationship was observed for PT1 (FIG. 12). Barley samples treated with PT1 at a dose of 5.25 kg/T were still completely stable after 12 weeks storage. For the barley samples treated with 5.25 kg/T of PT2, ALT2 and Myco CURB ES liquid, more variation in CO2-level between the different replicates was observed (FIGS. 13, 14 and 15). The mold counts, determined at the end of the study, showed that the efficacy of PT2 and ALT2, dosed at 5.25 kg/T, was similar as Myco CURB liquid, dosed at 7 kg/T. The mold counts in all these treated samples were below the detection limit (2 log CFU/g) after 12 weeks of incubation (Table 10).

TABLE 10
Mold and yeast counts in untreated and treated barley samples,
at the end of the efficacy study (week 12). The data are shown
as mean values of triplicate counts ± standard deviations.
(CFU: colony forming units; n.c.: not countable due to overgrown
by molds). Detection limit of 2.00 log CFU/g.

| | Mold counts | Yeast counts |
|---|---|---|
| Treatments | (log CFU/g) | (log CFU/g) |
| Untreated control | 7.80 ± 2.10 | n.c. |
| Prototype 2 - 3.50 kg/T | 3.28 ± 1.96 | <2.00 |
| Prototype 2 - 5.25 kg/T | <2.00 | <2.00 |
| Alternative 2 - 3.50 kg/T | | |
| Alternative 2 - 5.25 kg/T | | |
| Myco CURB ES - 5.25 kg/T | | |
| Myco CURB ES - 7.00 kg/T | <2.00 | <2.00 |

### Trial 3

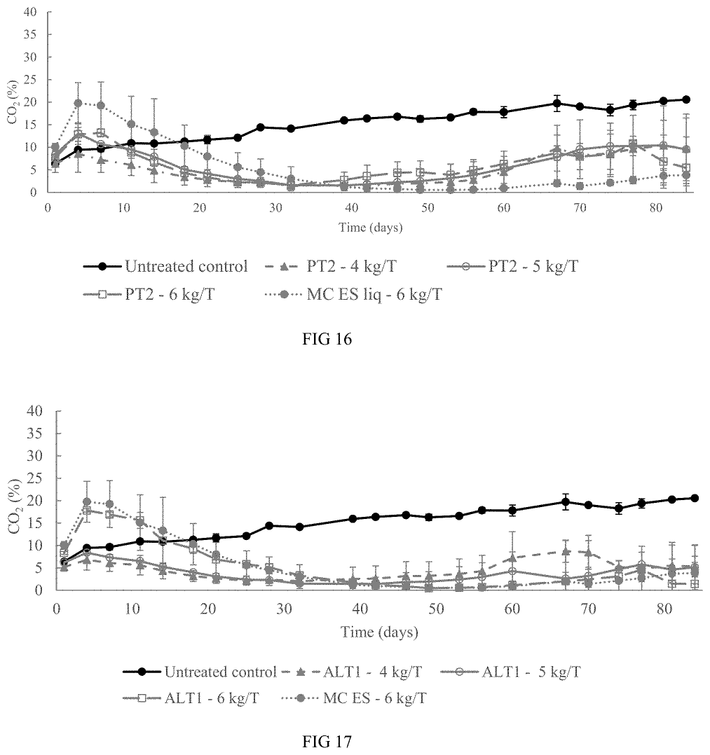

The CO2-production in the barley samples untreated and treated with PT2, ALT 2 in function of incubation time is shown in FIGS. 16 and 17. The barley samples treated with PT2 showed a similar evolution of CO2 production as in the second efficacy study. However, in this study, a faster decrease in CO2-level was observed for PT2 compared to Myco CURB ES liquid within the first three weeks while at the end of the study lower CO2-levels were measured for barley samples treated with Myco CURB ES liquid compared to PT2. The mold counts in the barley samples (Table 11) showed a similar efficacy for PT2 as for Myco CURB ES liquid compared to the untreated control. The mold counts were below the detection limit after 2 weeks incubation until the end of the study. The CO2 measurements of the barley samples treated with ALT1 (FIG. 17), showed a similar performance in controlling mold growth as Myco CURB ES Liquid. However, the counts of molds showed that in the barley samples treated with 4 kg/T of ALT1, molds started to grow eight weeks after treatment (Table 11). Only the highest dosage tested of ALT1 (6 kg/T) could prevent mold growth during a longer time (12 weeks after treatment).

TABLE 11
Mold counts at different time points in untreated and treated barley samples.
The data are shown as mean values of triplicate counts ± standard deviations.
(CFU: colony forming units). Detection limit of 2.00 log CFU/g.

| | Mold counts (log CFU/g) | | | |
|---|---|---|---|---|
| Treatments | Week 0 | Week 2 | Week 8 | Week 12 |
| Untreated control | 3.65 ± 0.14 | 5.47 ± 0.03 | 7.63 ± 0.10 | 8.06 ± 0.31 |
| Prototype 2 - 4 kg/T | 3.65 ± 0.14 | <2.00 | <2.00 | <2.00 |
| Prototype 2 - 5 kg/T | 3.65 ± 0.14 | <2.00 | <2.00 | <2.00 |
| Prototype 2 - 6 kg/T | 3.65 ± 0.14 | <2.00 | <2.00 | <2.00 |
| Alternative 1 - 4 kg/T | 3.65 ± 0.14 | <2.00 | 2.60 ± 0.85 | 6.71 ± 0.13 |
| Alternative 1 - 5 kg/T | 3.65 ± 0.14 | <2.00 | <2.00 | 6.83 ± 0.07 |
| Alternative 1 - 6 kg/T | 3.65 ± 0.14 | <2.00 | <2.00 | <2.00 |
| Myco CURB ES - 6 kg/T | 3.65 ± 0.14 | <2.00 | <2.00 | <2.00 |

### Example 13

### Efficacy in a Challenging Matrix with High Acid Binding Capacity (Soybean Meal)

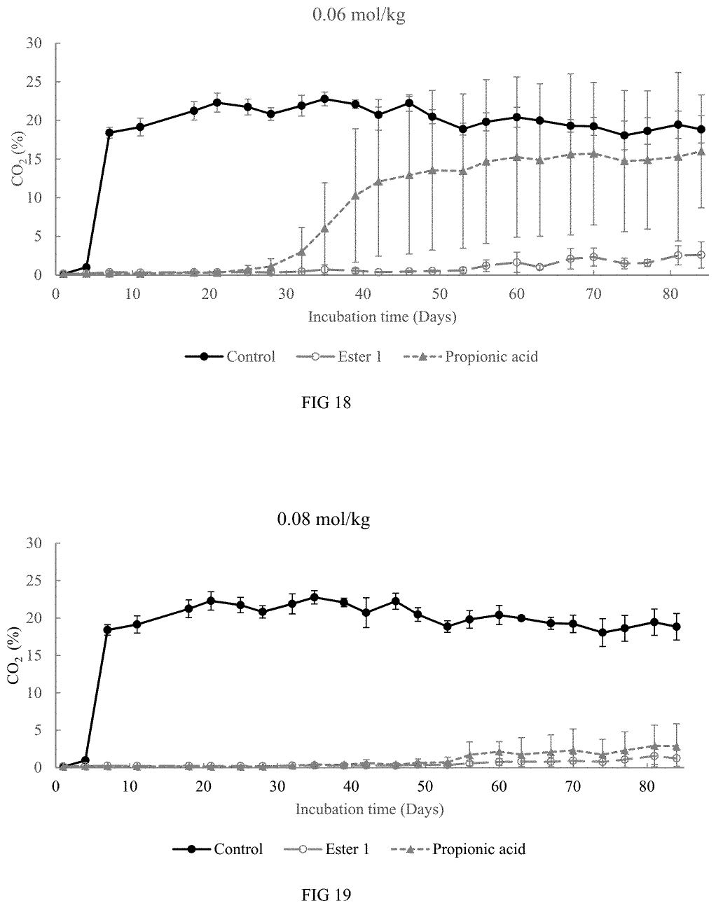

Efficacy on soybean meal. FIGS. 18 and 19 show the CO2 production (%) of the untreated soybean meal samples compared to the soybean meal samples treated with ester 1 and propionic acid at a dosage of 0.06 and 0.08 mol/kg, respectively. In the untreated samples, a fast increase in CO2 level was measured within the first days and the CO2 value stayed around 20% during the whole course of the trial. The CO2 production was statically significantly lower for all tested treatments compared to the untreated control. After one month of storage, CO2 levels started to increase in the soybean meal samples treated with 0.06 mol/kg propionic acid while soybean meal samples treated with 0.06 mol/kg of ester 1 were still completely stable after 84 days storage. Over the course of the study, the CO2 level of the soybean meal samples treated with 0.06 mol/kg of ester 1 was statistically lower compared to soybean meal samples treated with the same dosage of propionic acid. Samples treated with ester 1 and propionic acid at a dosage of 0.08 mol/kg were still completely stable after 84 days.

### Example 14

### Evaluation of Propylene Glycol Valerate (Mono and Diester) in Terms of CO2 Efficacy Study in Comparison to the Myco CURB ES Liquid

Efficacy test with carbon dioxide (CO2) production test. CO2 test was carried out in barley samples with adjusted moisture of 19.7%. The samples were treated with i) Myco CURB ES Liquid at 3.5 kg/ton, ii) propylene glycol propionate ester (containing mono and diesters in 4:1 ratio) at 0.06 mol/kg, and iii) extracted valeric acid esters (comprising of mono and diesters at 1:2 ratio) at 0.02-0.08 mol/kg, for comparison at both molar and weight equivalents. Treated samples were stored in tight-fitted plastic containers for analysis. The CO2 production was monitored over 12 weeks at ambient conditions, using Edinburgh sensor Guardian NG. Tests were carried out in triplicates.

Statistical analysis. Means of triplicates were reported for both efficacy tests. The mean comparisons for well diffusion assay test results were analyzed using Tukey's multiple range test using STATGRAPHICS Centurion 18 software. Differences between means were considered significant at p-value<0.05.

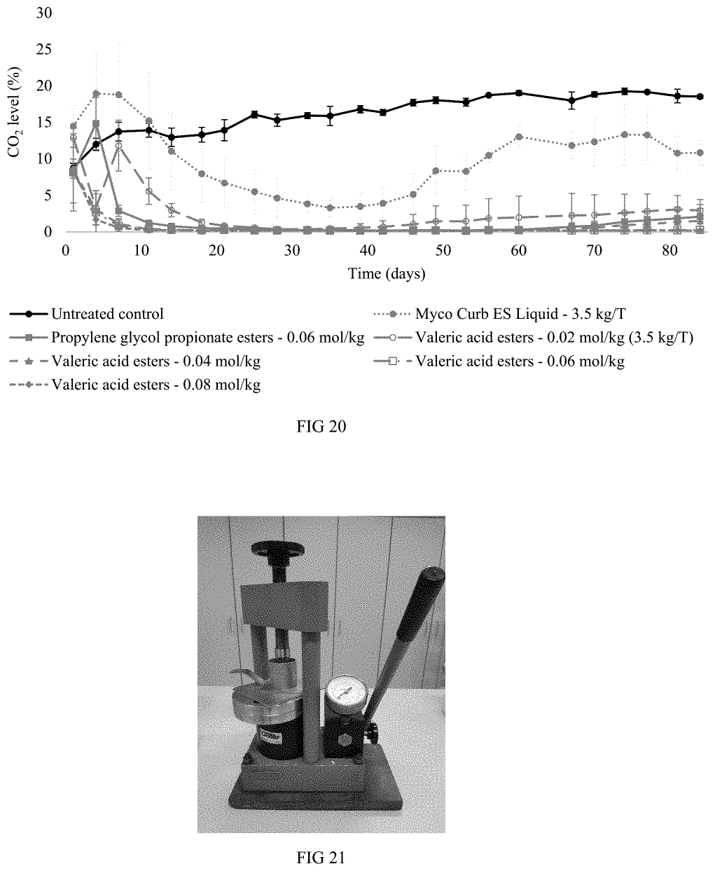

Carbon dioxide (CO₂) production test. The CO₂ test was conducted in barley grains with adjusted moisture of 19.7%, in comparison to other commercially-available products, such as Myco CURB ES Liquid and propylene glycol propionate, at comparable dosages and molar equivalents (FIG. 20). A spike in the CO₂ level was observed at the initial stage of the study for all samples. Treatments with valeric acid esters and propylene glycol propionate esters could bring the CO₂ level down within the next 10-20 days. A slower decrease in CO₂ level was observed with Myco CURB ES Liquid over the next 30 days followed by an increase in the CO₂ level. Valeric acid ester treatment outperformed that of Myco CURB ES Liquid at 3.5 kg/tonne where CO₂ level hovers at 2.9% in comparison to 10.8% with Myco CURB ES Liquid. Additionally, valeric acid esters, at 0.02-0.08 mol/kg were effective in inhibiting mold growth at the tested dosages where CO₂ level was maintained at below approximately 3.0% throughout 12 weeks. In comparison, 0.04 mol/kg of valeric acid esters could achieve comparable efficacy as propylene glycol propionate at 0.06 mol/kg.

Carbon dioxide (CO₂) production test revealed that valeric acid esters are more effective than Myco CURB ES Liquid at 3.5 kg/ton where valeric acid esters can maintain the CO₂ level at 2.9% in comparison to Myco CURB ES Liquid at 10.8%. On conversion, 3.5 kg/ton of Myco CURB ES Liquid is equivalent to 0.03 mol/kg of propionic acid. This thus indicates that a much higher concentration of propionic acid is required to achieve a comparable efficacy as valeric acid esters. The assay conditions could have accounted for the differences observed where test conditions of CO₂ production test (with feed samples at high moisture of 19.7%) could have favored the hydrolysis of esters. Lower concentration of valeric acid esters is required to achieve a comparable CO₂ level as propionic acid esters where similar CO₂ production trend was observed between 0.04 mol/kg of valeric acid esters and 0.06 mol/kg of propionic acid esters. This indicates that valeric acid esters is potentially 1.5 times more effective than propionic acid esters in inhibiting mold. The longer carbon chain in valeric acid allows the acid to better penetrate the cell membrane of mold and thus enhancing its antifungal effects.

### Example 15

### Moisture Retention Capacity of Propionic Acid Esters

Moisture loss during feed storage is one of the major challenges in feed industry. This leads to a considerable weight reduction of the feed bags and also affects feed quality parameters like pellet durability index (PDI). Predominantly, free form of water can more easily evaporate than the bound of entrapped form during high temperature and low humidity conditions, because of its weaker interactions with other molecules. By addition of ingredients that improve water absorption to the feed particles, the water holding capacity of the feed can be increased. Propylene glycol (MPG) is a substance commonly used in many cosmetic products or as an additive in foods2. MPG is used as humectant in cosmetics to increase moisture retention in skin. MPG has also been shown to be a sensitizing agent that contributes to irritation and contact dermatitis. In food products, MPG is commonly used to guarantee long shelf life. It helps food products maintain a stable level of moisture and thus prevents them drying out. In intermediate moisture foods (IMFs), having water activities between 0.6 and 0.84, MPG is often used as humectant for water activity adjustment to insure the shelf life4. MPG is expected to also affect the quality of compound feed pellets because general binding forces of feed particles and water activity in the feed may be influenced. A novel class of ingredients was recently developed 5,6. Propylene glycol propionate esters completely masked the pungent odour of propionic acid and were shown to be less volatile. Based on their chemical structure, it is expected that propylene glycol propionate esters will have similar or better moisture-retaining characteristics compared to MPG. The objective of this study was to evaluate if the propylene glycol propionate esters can convert the free form of water into a bound or entrapped form in a feed matrix. A method, developed by KAA, was used to evaluate the moisture retention capacity of the different products7. In this study, the moisture retention capacity of the extracted and purified propylene glycol propionate ester was compared to MPG, propionic acid and water.

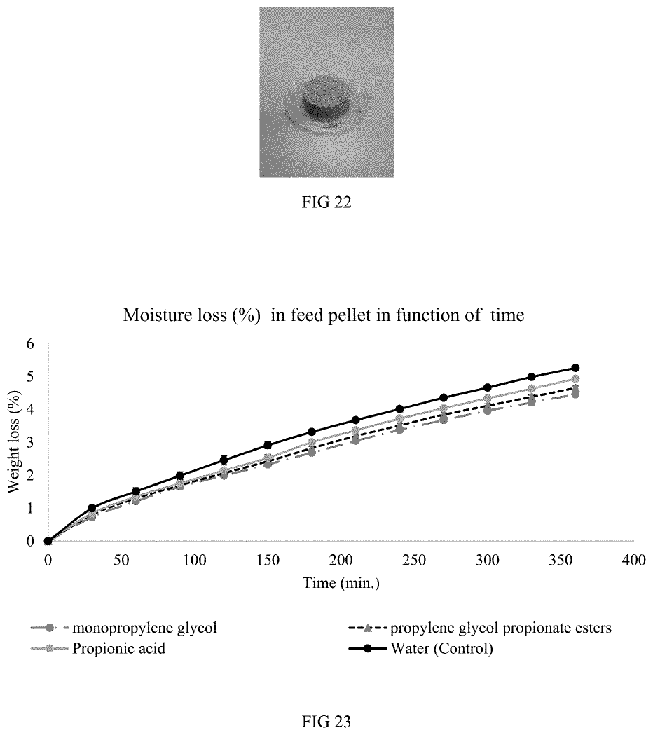

Moisture retention test. Thirty grams of ground mash broiler feed (AVEVE, Belgium) were weighed in a zip lock bag. Nine g of water (85° C.) and one g of product were mixed well using vortex and added to the feed (10 g of water for control). The treatments are shown in Table 12. The liquid and ground feed were mixed well to form a dough that was placed in a metal mold and pressed with a pressing force of 4 tons (Beckmann press, FIG. 21) to even the surface, forming a pellet with a diameter of 5 cm (FIG. 22). The pellet is then placed on a pre-weighed petri dish. This process takes about 2-3 minutes. After this process, the initial weight of the pellet together with pre-weighed petri dish was measured. Weight was recorded every 30 minutes for 6 hours. The weight loss (%) during storage was calculated for the different treatments. Three replicates were analyzed for each treatment. The conditions in the lab were 21° C. and 36% humidity.

TABLE 12
Overview of the treatments

| | | Dosage |
|---|---|---|
| Treatment | Product | (mol/kg feed) |
| T1 | Untreated control (water) | — |
| T2 | MPG | 0.438 |
| T3 | Propylene glycol propionate ester* | 0.200 |
| T4 | Propionic acid | 0.450 |

*mixture of propionic acid monoester (28%)/di-ester (68%)), 2% MPG and 2% Propionic acid

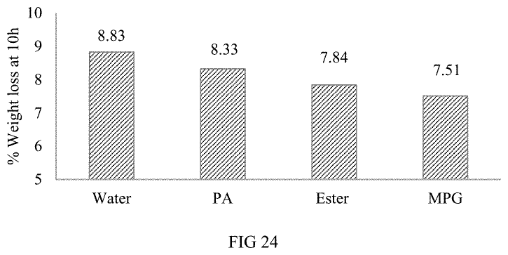

Results. In FIG. 23, the kinetics of weight loss are represented and could be described by an exponential phase followed by a linear phase. Curves were used to extrapolate the percentage of weight loss at 10 hrs. This weight loss at 10 hrs is represented on FIG. 24. MPG showed the highest retention of water in the feed. For the propylene glycol propionate ester, a better moisture retention was observed compared to water and propionic acid. While a slightly lower moisture retention was observed for the ester compared to MPG, it is important to note that the dosage of ester (mol/kg feed) is lower compared to MPG (Table 12).

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It is also to be understood that the formulations and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, 10) contained within the range. In this specification and the appended claims, the singular forms “a,” “an” and “the” include plural reference unless the context clearly dictates otherwise. All combinations of method steps or process steps as used herein can be performed in any order, unless otherwise specified or clearly implied to the contrary by the context in which the referenced combination is made

To the extent that the terms “includes” or “including” or “have” or “having” are used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A” or “B” or both “A” and “B”. When the Applicant intends to indicate “only A or B but not both” then the term “only A or B but not both” or similar structure will be employed. Thus, use of the term “or” herein is the inclusive, and not the exclusive use. Also, to the extent that the terms “in” or “into” are used in the specification or the claims, it is intended to additionally mean “on” or “onto.” In this specification and the appended claims, the singular forms “a,” “an” and “the” include plural reference unless the context clearly dictates otherwise.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. A mold inhibitor composition that contains at least one propylene glycol ester of propionic acid or derivatives and propylene glycol in an amount effective to inhibit or delay the growth of mold in animal feed, wherein the composition is less corrosive to stainless steel than propionic acid alone, and the composition has a lower vapor pressure than propionic acid under the same physical conditions.

2. The composition of claim 1, wherein the at least one propylene glycol ester is propylene glycol mono-, and di-ester.

3. The composition of claim 1, wherein the at least one propylene glycol ester is derived from monopropylene glycol.

4. The composition of claim 1, wherein the composition further comprises one or more organic acids selected from the group consisting of propionic acid, acetic acid, sorbic acid, and benzoic acid.

5. The composition of claim 1 further comprising at least one fatty acid.

6. The composition of claim 1 further comprising at least one surfactant.

7. The composition of claim 1, further comprising water.

8. The composition of claim 1, wherein the composition is a liquid or dry product.

9. A mold inhibitor composition that contains at least one propylene glycol ester of valeric acid or derivatives and propylene glycol in an amount effective to inhibit or delay the growth of mold in animal feed, wherein the composition is less corrosive to stainless steel than valeric acid alone, and the composition has a lower vapor pressure than valeric acid or propionic acid under the same physical conditions.

10. The composition of claim 9, wherein the at least one propylene glycol ester is propylene glycol mono-, and di-ester.

11. The composition of claim 9, wherein the composition further comprises one or more organic acids selected from the group consisting of propionic acid, acetic acid, sorbic acid, and benzoic acid.

12. The composition of claim 9, further comprising at least one fatty acid.

13. The composition of claim 9, further comprising at least one surfactant.

14. The composition of claim 9, further comprising water.

15. The composition of claim 9, wherein the composition is a liquid or dry product.

16. A method for reducing mold contamination in feed or food, comprising the step of adding to the feed or the food a composition that contains a propylene ester or derivatives in an amount effective to inhibit or delay the growth of mold, wherein the composition is less corrosive to stainless steel than propionic acid alone and the composition has a lower vapor pressure than propionic acid under the same physical conditions.

17. The method of claim 16, wherein the at least one propylene glycol ester is propylene glycol mono-, and di-ester.

18. The method of claim 16, wherein the composition further comprises one or more organic acids selected from the group consisting of propionic acid, acetic acid, sorbic acid, and benzoic acid.

19. The method of claim 16, wherein the composition further comprises at least one fatty acid.

20. The method of claim 16, wherein the composition further comprises at least one surfactant.

21. The method of claim 16, wherein the composition further comprises water.

22. The method of claim 16, wherein the composition is a liquid or dry product.

23. The method of claim 16, wherein the composition is added to the animal feed in an amount ranging from about 0.5 to about 10.0 kg/tonne of feed.

24. The method of claim 16, wherein the composition is added to the feed in an amount ranging from about 2.7 to about 5.0 kg/tonne of feed.

25. A feed additive comprising at least one fatty acid, at least one propylene glycol mono-, and di-ester of propionic acid or derivatives, and propylene glycol, wherein the at least one fatty acid and the at least one ester is present in an amount effective to mitigate or control the growth of mold in the feed wherein the composition is less corrosive than propionic acid and the composition has a lower vapor pressure than propionic acid.

26. A composition for moisture retention in animal feed comprising a mixture of volatile fatty acids and their mono, di-propylene glycol esters, and monopropylene glycol.

27. The composition of claim 25, further comprising an acid buffer.

28. The composition of claim 25, wherein the acid buffer is ammonium propionate.

29. The composition of claim 25, further comprising water.

30. An animal feed additive comprising:
at least one monopropylene glycol propionate and/or di-propylene glycol propionate in an amount ranging from about 1% to 90% weight,
at least one organic acid in an amount ranging from about 1%-50% weight,
at least one carboxylic acid salt in an amount ranging from about 5-40% weight, and monopropylene glycol in an amount ranging from about 1-10% weight.

31. The animal feed additive of claim 30, wherein the at least one organic acid is selected from the group consisting of propionic acid, acetic acid, sorbic acid, and benzoic acid.

32. The animal feed additive of claim 30, further comprising at least one fatty acid.

33. The animal feed additive of claim 30, further comprising at least one surfactant.

34. The animal feed additive of claim 30, wherein the at least one surfactant is present in an amount ranging from about 0.1 to 5% weight.

35. The animal feed additive of claim 30, further comprising water in an amount ranging from about 0.1 to 50% weight.

36. The additive of claim 30, wherein the carboxylic acid salt is ammonium propionate salt.

37. The additive of claim 30, further comprising water.

38. A method for extending the shelf-life of animal feed or feed ingredients by preventing contamination of mold comprising incorporating in said animal feed or feed ingredients a composition comprising:
at least one monopropylene glycol propionate and/or di-propylene glycol propionate in an amount ranging from about 1% to 90% weight,
at least one organic acid in an amount ranging from about 1%-50% weight,
at least one carboxylic acid salt in an amount ranging from about 5-40% weight, and
monopropylene glycol in an amount ranging from about 1-10% weight.

39. The method of claim 38, wherein the composition is incorporated at a rate of at least 1% by weight.

40. The method of claim 38, wherein the composition is applied by spraying the composition onto the animal feed or feed ingredients.
